(19) United States
(12) Patent Application Publication
(10) Pub. No.: US 2020/0167876 A1
(43) Pub. Date: May 28, 2020

(54) SYSTEM FOR CONNECTING PREPARED FOOD PROVIDERS WITH FOOD CUSTOMERS TO PROMOTE CULTURAL UNDERSTANDING

(71) Applicant: Foodie Moodie LLC, Charlotte, NC (US)

(72) Inventor: Ammar Ramadneh, Charlotte, NC (US)

(21) Appl. No.: 16/695,934

(22) Filed: Nov. 26, 2019

Related U.S. Application Data
(60) Provisional application No. 62/772,222, filed on Nov. 28, 2018.

(51) Int. Cl. G06Q 50/12; G06Q 10/08; G06Q 30/06; G06Q 10/06

(52) U.S. Cl. CPC G06Q 50/12; G06Q 10/0833; G06Q 30/0641; G06Q 20/3223; G06Q 30/0639; G06Q 10/06311; G06Q 30/0633

(57) ABSTRACT

A method or system for connecting food providers with food customers, so that cultural experiences are shared to promote understanding, includes the steps of: building a database of food providers where each food provider lists, at least, a location, meal offerings, and meal prices; building a database of deliverers, each deliverer being trackable and the tracking information resides in the database; where: the food customer interfaces with the food provider's database and orders an offering, the food provider accepts the order, the customer pays for the offering, and notifying a deliverer, based on tracking information, and offering the delivery to the notified deliverer, if the deliverer accepts the delivery, offering delivery is affected, if the deliverer declines the delivery, the deliverer notification process is repeated until accepted.

### RELATED APPLICATION

This application claims the benefit of co-pending application U.S. Provisional Application Ser. No. 62/772,222 filed Nov. 28, 2018, incorporated herein by reference.

### FIELD OF THE INVENTION

This invention is directed to an internet system to promote cultural understanding where food customers select and order prepared foods from providers and the system includes an delivery function.

### BACKGROUND OF THE INVENTION

Food providers (restaurants, caterers) want to share their meals with food customers (individuals or groups). Traditionally, this required the customer to visit the food provider. But the internet has changed that, providers can reach those customers over the internet. It has been difficult for individual food providers to share their offerings with one another. An individual food provider may want to share their cultural heritage, in the form of food offerings, with others as a way to promote intercultural understanding.

Accordingly, there is a need for a method or a system where food providers can connect with food customers and offer a simple method for ordering prepared foods and having them delivered. Additionally, there is a need for a way to promote intercultural understanding via food.

### SUMMARY OF THE INVENTION

A method or system for connecting food providers with food customers, so that cultural experiences are shared to promote understanding, includes the steps of: building a database of food providers where each food provider lists, at least, a location, meal offerings, and meal prices; building a database of deliverers, each deliverer being trackable and the tracking information resides in the database; where: the food customer interfaces with the food provider's database and orders an offering, the food provider accepts the order, the customer pays for the offering, and notifying a deliverer, based on tracking information, and offering the delivery to the notified deliverer, if the deliverer accepts the delivery, offering delivery is affected, if the deliverer declines the delivery, the deliverer notification process is repeated until accepted.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of the method or system.

FIG. 2 is a flowchart of the method or system.

### DESCRIPTION OF THE INVENTION

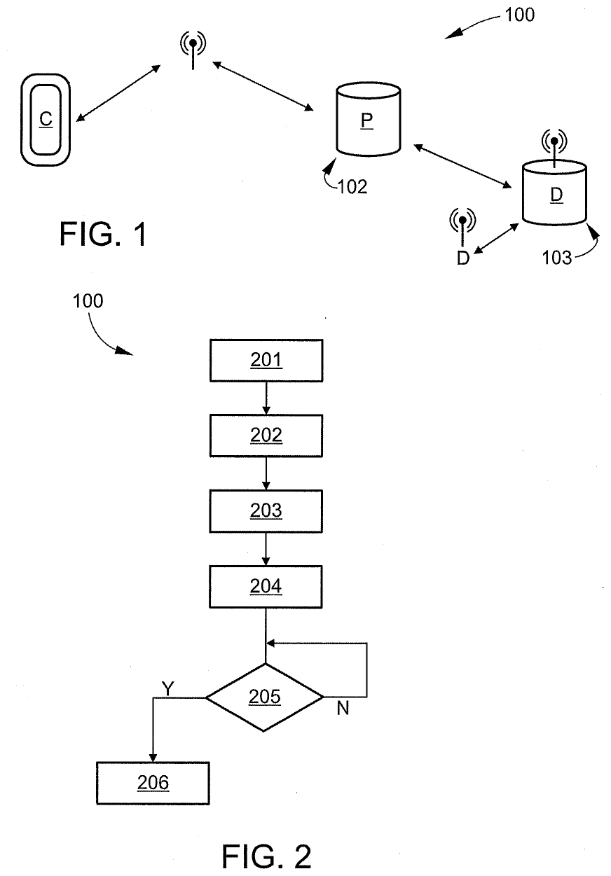

The instant invention is a method or system 100 for connecting food customers (C) with food providers (P) and affecting delivery, via a deliverer (D). Referring to figures, where like indicators refer to like elements, there is shown in FIG. 1 a schematic illustration of the present invention and in FIG. 2 a flowchart illustrating some of the steps of the present invention. In general, a plurality of Ps upload information (e.g., offerings) into a database 102, and a plurality of Ds, with trackable locations, are uploaded in a database 103. C searches the database 102 and orders one of P's offering. P accepts C's order. And, C pays for the order. Then, D is notified of the order, based on, at least, D's location (i.e., trackable information) and if D accepts the delivery, the delivery is affected, but if D declines the delivery, the notification process is repeated until delivery is accepted.

The application with the databases resides in the cloud (or similar concepts) and is accessible via the internet, as is well known in the art, see for example, Cloud Computing, Wikipedia, incorporated herein by reference. Users of the application, for example, customers (C), providers (P), deliverers (D), and others (e.g., system operators) may use a smart device (e.g., cellphone, tablet, PDA) or computer to access the application. P is an individual, but may also be a restaurant and/or caterer.

P uploads information into the database 102. That information may include, for example, provider location(s), meal offerings, and meal prices. Additionally, P may categorize their information by type (Asian, American, Italian, Middle Eastern, or the like), provide descriptions of the meal, and/or provide pictures of the meal.

D joins the application to deliver orders secured via the application. D uploads their information into the database 103 and are trackable (and tracking information is stored in the database 103, in real time). Tracking may be accomplished by any means including: global positioning system (GPS) or a mobile phone tracking system (MPT), both well known as indicated by the Wikipedia articles entitled: Global Positioning System and Mobile phone tracking, both incorporated herein by reference. Once the order is accepted and prepared (i.e., ready for delivery or shortly available for delivery) the application notifies D, based on the real time tracking information and, for example, availability, of the order and offers the delivery to D. D may accept or decline the delivery.

C searches, via a smart device or computer, the database 102. C chooses and orders and offering from the database 102.

In operation, the application may perform as follows:

201—C accesses database 102 via a smart device and/or a computer and searches, via filters, for an offering. The filters may include, location, type of food, price, availability, or the like. C provides their location information, either directly, via input, or indirectly, via GPS or MPT

202—C chooses and orders an offering found in database 102 and that order is noted on a C dashboard and a P dashboard.

203—P accepts the order by accepting the notice posted on the P dashboard.

204—C, via the C dashboard, decides on a delivery preference, for example, pick-up or delivery. If delivery is chosen, the application proceeds to 205, after C pays for the order, order payment is facilitated via the application, in any conventional manner.

205—the application, using, for example, D's tracking information (e.g., location of C and P, proximity of D to either C or P, traffic conditions, and/or others) and D's availability, notifies D that an order is available (e.g., ready or nearly ready) for delivery. More specifically, the application considers, for example, D's availability and D's proximity to P (and/or other considerations, such as, traffic, previous number of deliveries (or deliveries per time period, e.g., shift), vehicle size (relative to order), and the like. D may accept or decline the delivery. If the delivery is accepted, D is marked as temporally unavailable until delivery completion. If the order is declined, the delivery process is repeated until delivery is accepted. The delivery function may be performed before or after payment for the order.

206—delivery is completed.

The present invention may be embodied in other forms without departing from the spirit and the essential attributes thereof, and, accordingly, reference should be made to the appended claims, rather than to the foregoing specification, as indicating the scope of the invention.

I claim:

1. A method for connecting food providers with food customers, so that cultural experiences are shared to promote understanding, comprises the steps of:
building a database of food providers where each food provider lists, at least, a location, meal offerings, and meal prices;
building a database of deliverers, each deliverer being trackable and the tracking information resides in the database;
where:
the food customer interfaces with the food provider's database and orders an offering,
the food provider accepts the order,
the customer chooses a delivery option and pays for the offering, and
notifying a deliverer, based on, at least, tracking information, and offering the delivery to the notified deliverer,
if the deliverer accepts the delivery, offering delivery is affected,
if the deliverer declines the delivery, the deliverer notification process is repeated until accepted.

2. The method of claim 1 wherein notifying the deliverer is based on deliverer availability, and tracking information is proximity of the deliverer to the food provider.

3. The method of claim 1 wherein the delivery notification is performed before or after payment.

4. The method of claim 1 wherein the food provider is an individual or a restaurant, or a caterer.

5. The method of claim 1 wherein the food provider adding lists meal styles, meal descriptions, meal picture.

6. The method of claim 1 wherein the food customer interfaces with the food provider's database via a smart device connected to the internet.

7. The method of claim 1 wherein the smart device is a smart phone, a tablet, a PDA, and/or a computer.

8. The method of claim 1 wherein the food providers database is categorized, by location, price, and meal offerings.

9. The method of claim 1 wherein the tracking information is provided by a global positioning system (GPS) or a mobile phone tracking system (MPT).

10. A method for connecting food providers with food customers, so that cultural experiences are shared to promote understanding, comprises the steps of:
building a database of food providers where each food provider lists, at least, a location, meal offerings, meal prices, meal styles, meal descriptions, and meal pictures, and the food provider is a an individual;
building a database of deliverers, each deliverer being trackable and the tracking information resides in the database;
where:
the food customer interfaces, via a smart device connected to the Internet, with the food provider's database and orders an offering,
the food provider accepts the order,
the customer chooses a delivery option and pays for the offering after the food provider accepts the order, and
notifying a deliverer, based on, the deliverer availability and tracking information, the tracking information is proximity of the deliverer to the food provider and is provided by a global positioning system (GPS) or a mobile phone tracking system (MPT), and offering the delivery to the notified deliverer,
if the deliverer accepts the delivery, offering delivery is affected,
if the deliverer declines the delivery, the deliverer notification process is repeated until accepted.

11. A system for connecting food providers with food customers, so that cultural experiences are shared to promote understanding, comprises:
a database of food providers where each food provider lists, at least, a location, meal offerings, and meal prices;
a database of deliverers, each deliverer being trackable and the tracking information resides in the database;
where:
the food customer interfaces with the food provider's database and orders an offering,
the food provider accepts the order,
the customer chooses a delivery option and pays for the offering, and
the system notifies a deliverer, based on, at least, tracking information, and offers the delivery to the notified deliverer,
if the deliverer accepts the delivery, offering delivery is affected,
if the deliverer declines the delivery, the deliverer notification process is repeated until accepted.

12. The system of claim 11 wherein notifying the deliverer is based on deliverer availability, and tracking information is proximity of the deliverer to the food provider.

13. The system of claim 11 wherein the delivery notification is performed before or after payment.

14. The system of claim 11 wherein the food provider is an individual or a restaurant or a caterer.

15. The system of claim 11 wherein the food provider additionally lists meal styles, meal descriptions, and/or a meal picture.

16. The system of claim 11 wherein the food customer interfaces with the food provider database via a smart device connected to the internet.

17. The system of claim 11 wherein the smart device is a smart phone, a tablet, a PDA, and/or a computer.

18. The system of claim 11 wherein the food providers database is categorized, by location, price and meal offerings.

19. The system of claim 11 wherein the tracking information is provided by a global positioning system (GPS) or a mobile phone tracking system (MPT).
